(19) United States
(12) Patent Application Publication
(10) Pub. No.: US 2011/0170016 A1
(43) Pub. Date: Jul. 14, 2011

(54) Speaker System

(76) Inventor: Robert Abraham, Surrey (GB)

(21) Appl. No.: 13/061,489

(22) PCT Filed: Aug. 21, 2009
(86) PCT No.: PCT/GB2009/002050

§ 371 Date: Apr. 1, 2011

(30) Foreign Application Priority Data
Aug. 27, 2008 (GB) 0815537.6

(51) Int. Cl. H04N 5/60

(52) U.S. Cl. 348/738; 348/E05.122

(57) ABSTRACT

The invention relates to a speaker system of a type which can be provided to operate in conjunction with a display screen, monitor, television set or the like. The system includes one or more speakers and can be mounted and located with the television set. Typically the system utilises an amplifier provided in the television set or other apparatus connected thereto and therefore receives the amplified audio signal to operate the speakers from the television set or other apparatus. The invention therefore allows an amplified speaker system to be provided to be used in conjunction with existing television apparatus and therefore improves the audio effect to the user with respect to any speakers already provided within the television set, but without the need to provide the speaker system itself with an amplifier.

The invention to which this application relates is a speaker system, particularly, although not necessarily exclusively, for use in conjunction with a television set, display screen, monitor, projection screen or similar form of display device (hereinafter referred to as a television set in a non-limiting manner). The speaker system is provided to allow audio data which is received and processed by the television set to be generated via the speaker system thereby providing improved sound quality and/or functionality to the user/listener of the television set.

Conventionally, there are two forms of speaker systems provided for television sets. The first, and most common, type is to provide one or more speakers located integrally with and adjacent to the screen of the television set, with the said speakers and screen located within a common housing. A problem with this form of speaker provision is that the speakers tend to be of a relatively low quality, which can at least partly be due to space and cost constraints, and hence the audio quality can be poor and often not match the quality of the video which is being generated from the screen. This problem has been exacerbated by the advent of flat-screen TV's such as Plasma, LCD and the like which do not rely on the use of bulky CRT's, and so the size of the overall television set housing and hence available volume for receiving the speakers has reduced and with it, as a result, so has the sound quality which can be generated and, in particular, the bass audio performance.

The second type of speaker system which can be used is to provide one or more speakers which are connected to an amplifier which is provided in addition to the amplifier which is already provided as part of the television set. These additional speakers are therefore driven by the additional amplifier or audio visual processor, rather than the amplifier provided within the television set. The separate multi-channel Hi-Fi amplifier and processor delivers more power, offers more flexibility and delivers a level of sound quality through multiple speakers that is much closer to the true cinema sound experience. However it also has many problems, namely it is expensive, complicated to use and visually intrusive. There is also a need to run wires to numerous parts of the room in which the television set and speakers are provided and a need to accommodate not one but often six or more separate speakers.

The provision of the additional apparatus also means that the system purchase price is relatively expensive and, as a result, this form of speaker system is generally only purchased and used by relatively keen users of relatively “high quality” apparatus.

It has also been identified that while significant efforts have been made to improve the quality of the visual display of the television set, relatively little effort or development has been undertaken to try and improve the quality of the audio which is generated.

The aim of the present invention is to provide a speaker system which can be utilised to improve the sound quality and, furthermore, which can be provided in a form which allows the improvements to be attained without incurring significant additional expense and minimising the additional apparatus which is required to be provided in order to obtain the benefit.

In the first aspect of the invention there is provided a speaker system for use in conjunction with a television set, said television set including a display screen, at least one speaker and an amplifier for the same and wherein said speaker system incorporates at least one speaker and said system is connected to the television set to allow audio data received by the television set and processed and amplified by the same to be emitted via the at least one speaker of said speaker system.

In one preferred embodiment the at least one speaker of the speaker system is mechanically engaged with the television set directly or via a mounting means.

In one embodiment, the speaker system includes a plurality of speakers. In one embodiment, each of said speakers is separately mountable on the television set at differing locations thereon. Alternatively, the speakers of the speaker system are interconnected and/or located within a housing or on mounting means and it is the housing or mounting means which is mechanically located on the television set.

Typically, the speakers of the speaker system will be located to the side and/or base of the television set and facing forward in the same direction as the screen of the television set so that the sound is emitted from the speakers of the speaker system towards the location of a person who would be viewing the screen of the television set.

In one embodiment at least one of the speakers of the speaker system, but typically a number of the same, are mounted so as to be movable to a required position with respect to the display screen and/or other speakers. This ensures that the shape and dimensions of the speaker system can be adapted to suit the dimension of the display screen with which the same are used and/or to allow the user to create their required visual arrangement. Typically the movement will be to bring the length of the speaker system to match or lie within the width of the display screen.

In one embodiment, the audio connection between the speaker system and the television set is achieved via a cable connection through a headphone socket provided on the television set.

Typically, the speakers of the speaker system are provided with audio data from the amplifier of the television set via the electrical audio connection which therefore greatly reduces the cost of the system and also reduces the size and number of components required for the speaker system. Furthermore, as the speakers of the speaker system are mechanically mounted on the television set, the speaker system of the invention becomes an integral part of the television set, hence reducing the required location space for the speaker system.

In one embodiment the speakers of the speaker system can be used in conjunction with those already provided as part of the television set so that sound is emitted from all speakers. Alternatively when the speaker system is connected to the television set, the speakers of the television set are disabled.

In a further aspect of the invention there is provided a speaker system for use in conjunction with a television set, said television set including a display screen, at least one speaker and an amplifier for the same and wherein said speaker system incorporates at least one further speaker which is connected to operate using the amplifier of the television set.

In one embodiment the remote control and/or control means provided with or on the television set can be used to control the operation of the speakers of the speaker system.

In a further aspect of the invention there is provided an amplified speaker system which can be physically attached to a television set and wherein an amplifier provided on apparatus other than the speaker system is used to provide an amplified audio signal for use by the speakers of the speaker system.

Typically the speaker system can be adjusted in configuration so as to allow the same to be fixed to television sets of differing dimensions.

Typically the system is less expensive when compared to the multi-channel processor and amplifier based alternative.

Preferably, the speaker system, when attached, is integrated and visually non-intrusive, because the speakers are fixed to the TV and are discreet. In addition the invention is easy to use, because the TV still works in the conventional way and, in one embodiment, can be controlled by its original remote control. In this embodiment the speaker system receives a volume controlled signal from the audio connection, such as via the headphone socket output to which the same is connected. The connection to the headphone socket also typically disables the operation of the speakers provided with the television set such that the sound for the television set is emitted from the speaker system.

Alternatively, the amplified speaker system may be fed by a volume controlled line level audio feed from a source such as a digital data signal decoder device or set top box to which the speaker system is connected.

In one embodiment the digital audio can be obtained from the decoder device or set-top box and a variable delay is introduced in the digital domain to ensure synchronisation of the audio which is generated and the video display.

More typically the audio and video display which is generated is maintained in synchronisation by ensuring that the main or principle audio source is provided by the television set rather than any external apparatus connected thereto.

Typically the speaker system can receive the audio signal via one or more of the headphone output, analogue line output and/or digital line output.

In one embodiment, if the speaker system is to receive the audio signal via a non-volume controlled output, means are provided for use with or in the system to introduce a volume control stage. Typically the means can read or learn the volume control IR commands from the existing TV remote control handset.

In one embodiment the speaker system includes integral digital surround sound processing which derives its feed from the television set's digital output.

In one embodiment the speaker system includes least one speaker. In one embodiment the system includes a sub-woofer (also referred to as a 2.1 speaker) plus one or more additional speakers. In one embodiment separate, amplified, speakers can be provided as required for specific purposes. This can then considerably improve the reproduction of lower frequencies which are absent from the great majority of flat screen televisions.

In one embodiment, the amplified speakers can be operated and used independently of the television set.

In one embodiment the speaker system can be adapted to provide added functionality by way of connecting additional sources, such as external sources or sources built-in to the amplified speaker system.

In one embodiment the system may be provided to receive a digital audio source such as a 2 channel or multi-channel source which, in turn, can be processed within the amplified speaker system to facilitate various forms of multi-channel sound reproduction through a pair, or more, speakers.

Specific embodiments of the invention are now described with reference to the accompanying drawings wherein;

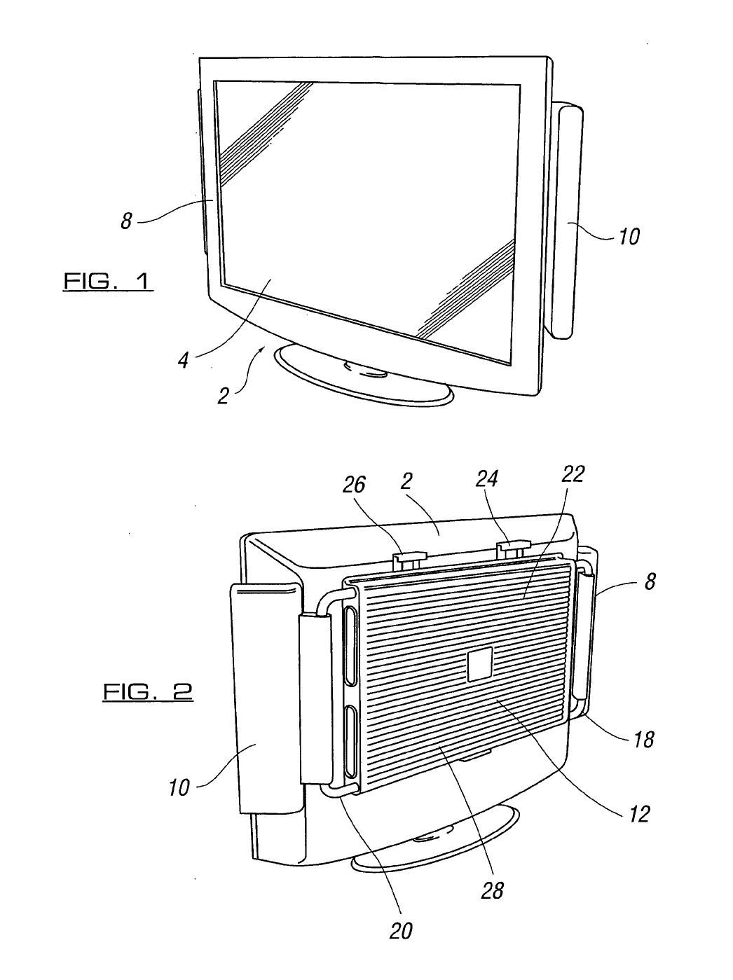

FIG. 1 illustrates a front view of a television set with the apparatus of the invention in accordance with one embodiment fitted thereto,

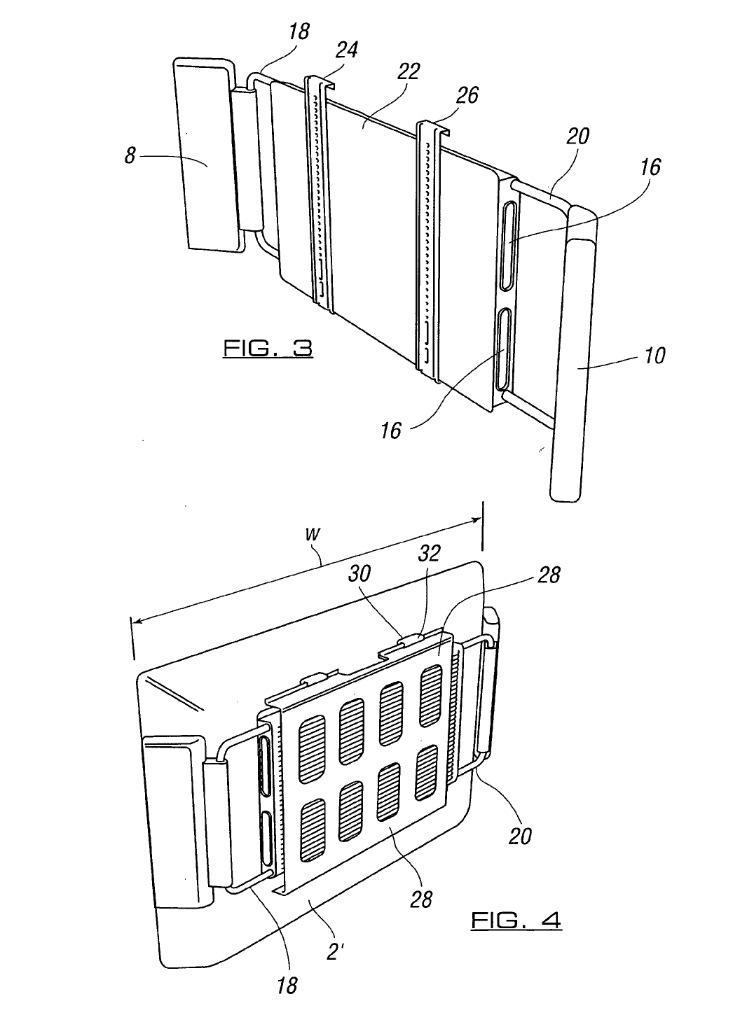

FIG. 2 illustrates a rear view of the television set of FIG. 1

FIG. 3 illustrates the apparatus in accordance with one embodiment of the invention removed from the television;

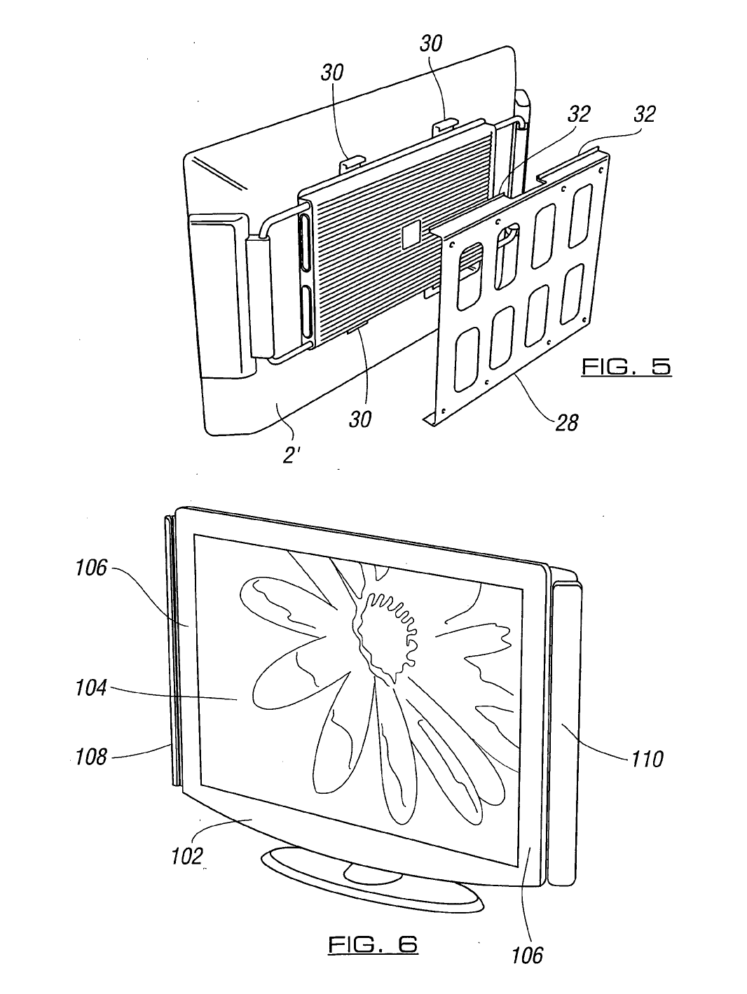

FIG. 4 illustrates the rear view of a television set of a different width to that of FIGS. 1-2, with the apparatus of the invention fitted thereto,

FIG. 5 illustrates the view of FIG. 4 with the apparatus of the invention partially removed;

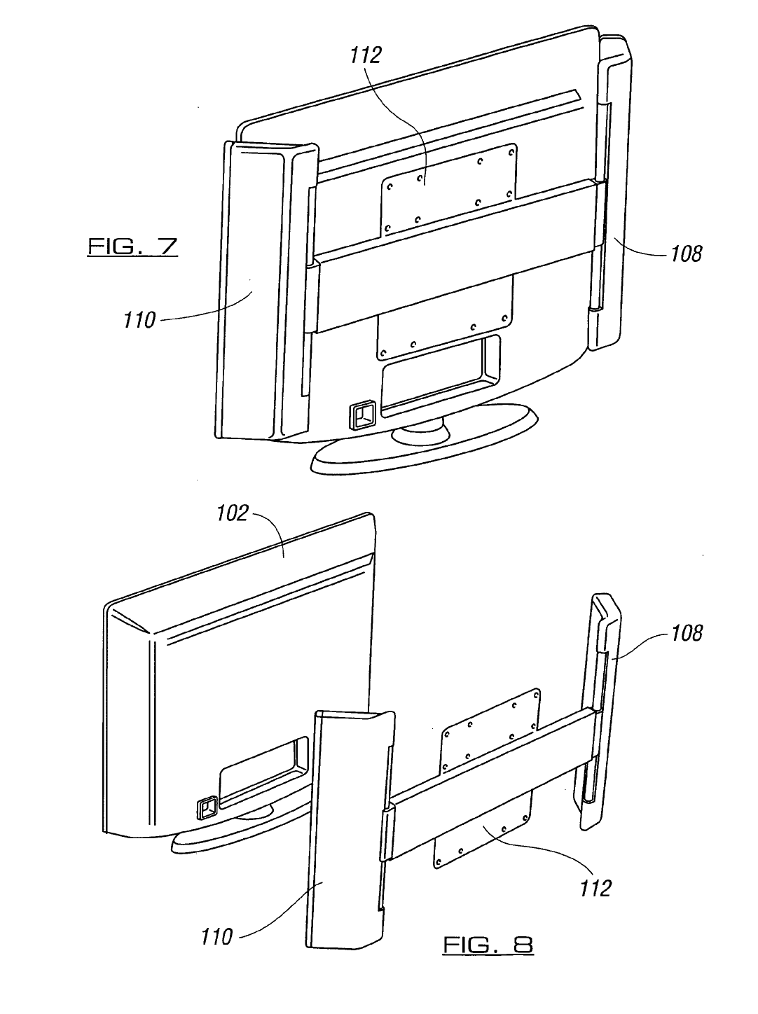

FIG. 6 illustrates a view of the front of a television set with a speaker system in accordance with one embodiment of the invention;

FIG. 7 illustrates a rear view of the television set of FIG. 6 illustrating the speaker system attached to the rear of the same;

FIG. 8 illustrates the rear view of FIG. 7 with the speaker system detached therefrom;

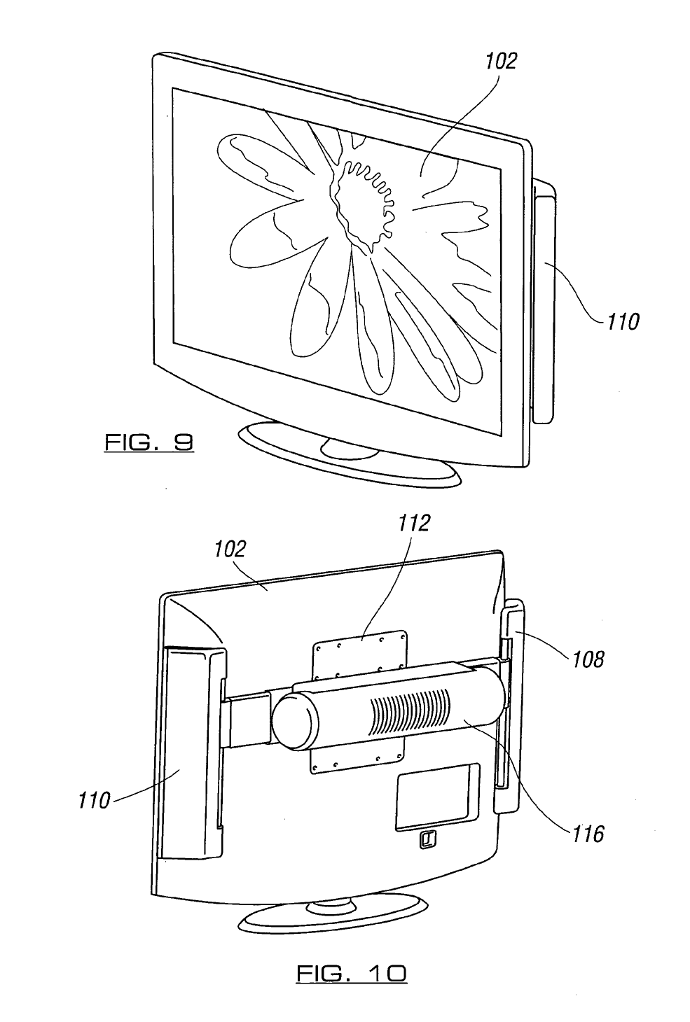

FIG. 9 illustrates a front view of a television set with a further form of speaker system in accordance with the invention;

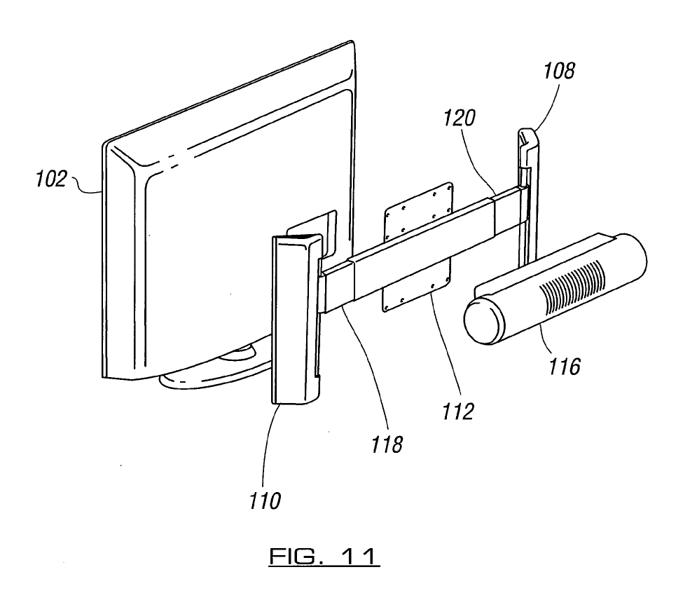

FIG. 10 illustrates rear view of the television set with the system of FIG. 9; and

FIG. 11 illustrates the rear view of the television set of FIG. 10 with the components detached therefrom.

In FIGS. 1-4 there is shown a television set 2 with a display screen 4 and, typically, integrated speakers (not shown).

In accordance with the invention there is provided a speaker system which includes speakers 8,10 mounted on a mounting means or holder 12 which is mechanically attached to the rear of the television set as shown in FIG. 2. The speakers 8,10 are provided on respective arm portions 18,20 which are connected to body 22. The body is provided with rails 24,26 and a mounting plate 28 is detachably attachable thereto via the reception of engagement means 30, 32. The rails 24,26 are attachable to the rear of the television set 2.

The body 22 may also include further speakers thereon, such as woofers or subwoofers 16.

FIGS. 4 and 5 show a second television set 2′ design which is of a greater width W than the television set of FIGS. 1 and 2. It can be seen that the arm portions have been slid outwardly so as to ensure that the speakers 8,10 are still mounted at the respective side edges of the television set. The mounting and positioning of the speakers 8,10 in the manner shown means that the visual impression of the television set from the front as shown in FIG. 1 is not unduly affected.

Referring now to FIGS. 6-8 there is shown a further embodiment of the invention. There is shown a television set 102 with a display screen 104 and integral speakers 106. In addition and in accordance with the invention, there are provided additional speakers 108, 110 mounted on a holder 112 which is again attached to the rear of the television set as shown in FIG. 7 such that the speakers are positioned along the peripheral vertical edges of the television set 102.

FIG. 9-11 illustrate a further variation on the system in which a further speaker such as a sub woofer, 116 is provided as part of the holder and supported via the holder 112 on the television set 102 at the rear of the same as shown. In one embodiment the sub woofer can be integrated with the mounting body so as to minimise the visual appearance of the same

In whichever embodiment the speakers' 8, 10; 108, 110, 16, 116 operation is typically driven via an amplifier provided on other apparatus, in this case via cable connection (not shown) between the speakers and holder and the headphone socket provided on the television set so as to allow the audio generated from the amplifier of the television set to be used. This therefore means that the additional speaker functionality and quality can be provided without the need for the additional expense of an additional amplifier being required on the speaker system.

Due to the connection of the speakers to the amplifier of the television set so the control of the speakers of the speaker system can be achieved by the user via the control means for the television set. This therefore allows the possibility of the user controlling the speakers of the speaker system via the existing television set remote control and with reference to the display screen 104 of the television set on which the control options can be displayed.

In one embodiment the speaker system comprises 2 drivers per satellite speaker 8, 10 and 4 drivers for a sub-woofer 16. The bandwidth can be 180 Hz-20 kHz per satellite and 50 Hz-180 Hz for the sub-woofer. The power amplification can be 25 Wrms per satellite speaker and 50 Wrms for the sub-woofer.

The outputs from the speaker system can include a headphone output on a mini-jack which mutes sound being emitted from the speakers when connected.

Control means can be provided to allow the user to control the gain and the tone or balance of the sub woofer. The Gain control will allow matching of the unit's input to the output level of the TV's headphone jack thus ensuring the desired volume range can be achieved using the TV's volume control.

The sub-woofer level adjustment is provided to allow balancing of the sound in differing room positions (close to a wall etc.). This may take the form of a direct sub-woofer level control or may be implemented as a form of tone control, depending on what works best. There may also be the option for different EQ settings to allow the sound to be tailored to the users taste, position of the satellite speakers etc. The DSP is powerful enough to have all these options implemented simultaneously.

Connection of the speaker system to obtained the amplified audio signal via the headphone output of the television set will ensure that the television speakers are muted and that the signal level is controlled by the user via the television set control means in the usual way. There can be provided an option for an AUXILIARY input to have a mini-jack on the speaker system which automatically cuts the signal from the television set when a jack is inserted which would allow an iPod, or similar, to be played through the speaker system. Alternatively, the two inputs can be mixed so that whichever input has a signal will be heard.

In one embodiment the system is provided to be automatically switched on and off in response to the switching on and off of the television set by the user.

The system of the present invention therefore provides a means which allows the user to operate a speaker system as if it is an integral part of the television set to which the same is attached, both mechanically and for the transfer of data while, at the same time, enjoying the significantly improved sound quality in comparison to the speakers provided with the television set.

The provision of the additional speakers means that improved quality of sound can be achieved and also, further audio options can be provided which would not be achievable using the integral speakers of the television set. The mechanical and electrical connection to the television set also allows certain functions of the television set to be available and utilised in both the operation of the additional speakers and the control of the same.

In addition to the advantages already discussed the provision of the speaker system as herein described in conjunction with a television set or display screen or monitor other system which displays video and uses audio in the manner described allows significant benefits to be achieved in terms of the bass audio effect which is created. Traditionally only a barely acceptable bass sound can be created by the speakers provided with television sets whereas with the current invention a greatly improved bass sound can be created via the connection and mounting of the speaker system with the television set, thereby greatly improving the overall sound effect which is achieved.

1. Audio and video apparatus, said apparatus comprising: a television set, including a display screen, at least one speaker and an amplifier for the same; and
an additional speaker system located in conjunction with the television set and incorporating a plurality of speakers, including a subwoofer and said additional speaker system being connected to the television set to allow audio data received by the television set and processed and amplified by the same to be emitted via speakers of said speaker system and control of operation of the speaker system is achieved by use of control means provided with or on the television set.

2. Apparatus according to claim 1 wherein the additional speaker system is mechanically located with the television set.

3. Apparatus according to claim 1 wherein the additional speaker system includes the plurality of speakers located on the television set.

4. Apparatus according to claim 3 wherein each of said plurality of speakers is separately mountable on the television set at differing locations thereon.

5. Apparatus according to claim 3 wherein the plurality of speakers of the additional speaker system are interconnected and/or located within a housing or on mounting means and the housing or mounting means is located on the television set.

6. Apparatus according to claim 3 wherein the plurality of speakers are located to the side and/or base of the television set and facing forward thereof.

7. Apparatus according to claim 1 wherein the plurality of speakers of the additional speaker system are positioned to emit sound towards the location of a person who would be viewing the screen of the television set.

8. Apparatus according to claim 1 wherein at least one of the plurality of speakers is mounted so as to be movable to a required position with respect to the television set and/or other speakers.

9. Apparatus according to claim 8 wherein the movement allows a length of the additional speaker system to match or lie within the width of the television set.

10. Apparatus according to claim 1 wherein a audio connection between the additional speaker system and the television set is achieved via a cable connection through a socket provided on the television set.

11. Apparatus according to claim 10 wherein the socket is a headphone socket.

12. Apparatus according to claim 1 wherein the speakers are provided with audio data from the amplifier of the television set.

13. (canceled)

14. Apparatus according to claim 1 wherein the plurality of speakers of the additional speaker system operate in conjunction with any speakers already provided as part of the television set so that sound is emitted from all speakers.

15. Apparatus according to claim 1 wherein when the additional speaker system is connected to the television set any speakers already provided as part of the television set are disabled.

16. Apparatus according to claim 1 wherein the additional speaker system includes mounting means for the plurality of speakers, said mounting means allowing mechanical connection of the system to the television set, said mounting means provided to a rear of the television set.

17. Apparatus according to claim 16 wherein the plurality of speakers are provided on respective arm portions which are connected to a body of the mounting means.

18. Apparatus according to claim 17 wherein the body is provided with rails attachable to the rear of the television set.

19. (canceled)

20. Apparatus according to claim 1 wherein the control means is a remote control device.

21. Apparatus according to claim 1 wherein the additional speaker system can be adjusted in configuration so as to allow the same to be located to television sets of differing dimensions.

22. An amplified speaker system for use as part of the apparatus of claim 1, said amplified speaker system including a plurality of speakers and provided for connection to the television set and an amplifier provided on the television set being used to provide an amplified audio signal for use by the plurality of speakers of the speaker system.

23. The amplified speaker system according to claim 22 wherein the speaker system receives a audio signal via one or more selected from the group consisting of a headphone output, analogue line output and digital line output.

24. The amplified speaker system according to claim 22 wherein the plurality of speakers of the system receives a volume controlled audio signal from the television set amplifier.

25. (canceled)

26. (canceled)

27. The amplified speaker system according to claim 22 wherein the speaker system is fed with a volume controlled line level audio signal from a source in the form of a digital data signal decoder device or set top box connected to the television set.

28. The amplified speaker system according to claim 27 wherein a variable delay is introduced in a digital domain to achieve synchronization of the audio and video signals.

29. (canceled)

30. The amplified speaker system according to claim 22 wherein, volume means are provided with the speaker system for introducing a volume control stage.

31. The amplified speaker system according to claim 30 wherein the volume means can read or learn volume control infrared commands from an existing television set remote control handset.

32. The amplified speaker system according to claim 22 wherein the system includes integral digital surround sound processing which derives feed from the television set's digital output.

33. The amplified speaker system according to claim 22 wherein the system includes at least one sub-woofer.

34. (canceled)

35. The amplified speaker system according to claim 22 wherein the system includes connection means for connecting to audio sources other than the television set such as external sources or sources built-in to an amplified speaker system.

36. (canceled)

37. (canceled)
